(19) United States
(12) Patent Application Publication
(10) Pub. No.: US 2016/0295155 A1
(43) Pub. Date: Oct. 6, 2016

(54) TUNER DEVICE

(71) Applicant: SONY CORPORATION, Minato-ku,Tokyo (JP)

(72) Inventors: TOMONORI NAKAJIMA, TOKYO (JP); MITSURU IKEDA, KANAGAWA (JP); TOSHIYUKI SUDO, TOKYO (JP)

(21) Appl. No.: 15/038,627

(22) PCT Filed: Nov. 28, 2014
(86) PCT No.: PCT/JP2014/005959

§ 371 Date: May 23, 2016

(30) Foreign Application Priority Data
Dec. 4, 2013 (JP) 2013-251261

(51) Int. Cl. H04N 5/50; H04N 5/64; H04B 1/08

(52) U.S. Cl. CPC H04N 5/50; H04B 1/08; H04N 5/64

(57) ABSTRACT

A housing has a vertical dimension, a horizontal dimension, a height dimension, a diagonal dimension, and an arbitrary dimension that are each shorter than a half wavelength of a maximum frequency of a source oscillation frequency of an oscillator of a tuner IC that is contained in the housing. Furthermore, pin positions in a pin connector including a plurality of pins connected to the tuner IC are arranged in a zig-zag manner, and the pin connector has a size shorter than a length decided by multiplying a number of the pins and a pin interval of the pin connector.

### TECHNICAL FIELD

The present disclosure relates to a tuner device for television broadcast reception, for example.

### BACKGROUND ART

In recent years, there is a high demand for size reduction of circuits, chip area reduction, and the like, in tuner devices used in television receiver devices and the like. Size reduction is intensively requested when a tuner device is equipped in a portable electronic terminal device, such as a notebook personal computer, a mobile phone, and a smartphone.

Many tuner devices are equipped with functional blocks such as a mixer, and additionally have a local oscillator configured with a voltage-controlled oscillator or the like as an integrated circuit (IC) (which is referred to as a tuner module or a tuner IC for example, and in the following referred to as a tuner IC). In order to achieve size reduction and chip area reduction, an oscillator is oscillated at a higher frequency and divided by a divider circuit or the like, to obtain local oscillation frequencies of a wide area.

In a tuner device, a substrate to which a tuner IC is attached is contained in a housing (a shield case) of an electrically conductive metal, and an F connector and an IEC (International Electrotechnical Commission) connector are attached to the housing (refer to Patent Literature 1, for example).

### CITATION LIST

### Patent Literature

Patent Literature 1: JP 2013-038520A

### SUMMARY OF INVENTION

### Technical Problem

Since the housing is made of electrically conductive metal, the housing resonates electrically by spurious radiation generated from the tuner device, so as to configure an antenna, and it is concerned that a spurious radio wave is radiated from the housing. Resonance of the housing is generated when a length (dimension) between both ends of a conductor configuring the housing which short or opens is approximately equal to λ/2. For example, if the frequency is equal to or less than 1 GHz, the wavelength λ is a large value of 30 cm or more, and therefore there is little necessity to consider the resonance with regard to the housing of the tuner IC.

However, as described above, when the frequency of the oscillator inside the tuner device is several GHz, for example 8 GHz, λ/2 is equal to 1.875 cm, and when the size of the housing of the tuner device is reduced, the housing resonates, it is concerned that spurious radiation is generated.

Thus, a purpose of the present disclosure is to prevent the resonance of the housing, and provide a small tuner device.

### Solution to Problem

The present disclosure is a tuner device including: a housing having a vertical dimension, a horizontal dimension, a height dimension, a diagonal dimension, and an arbitrary dimension that are each shorter than a half wavelength of a maximum frequency of a source oscillation frequency of an oscillator of a tuner IC that is contained in the housing. The tuner IC preferably includes a local oscillator, and processes a high-frequency signal of several GHz to 10 GHz. Furthermore, pin positions in a pin connector including a plurality of pins connected to the tuner IC are arranged in a zig-zag manner, and the pin connector has a size shorter than a length decided by multiplying a number of the pins and a pin interval of the pin connector.

### Advantageous Effects of Invention

According to at least one embodiment, the resonance of the tuner device is prevented, and generation of spurious radiation is prevented. Note that the effect described here is not necessarily limitative, but may be one of the effects described in the present disclosure.

### BRIEF DESCRIPTION OF DRAWINGS

FIG. 1 is a block diagram of a tuner device of the past to which the present disclosure can be applied.

FIG. 2 is a connection diagram illustrating a circuit configuration of an example of a local oscillator in a tuner device of the past and a schematic diagram illustrating its VCO curve.

FIG. 3 is a connection diagram illustrating a circuit configuration of another example of a local oscillator in a tuner device of the past and a schematic diagram illustrating its VCO curve.

FIG. 4 is a schematic diagram illustrating an exterior appearance of a tuner device of the past.

FIG. 5 is a schematic diagram for describing resonance of a shield case of a tuner device of the past.

FIG. 6 is a schematic diagram illustrating an example of dimensions of a shield case of one embodiment of the present disclosure.

FIG. 7 is a perspective view and a schematic diagram of an example of a pin connector.

FIG. 8 is a perspective view and a schematic diagram of another example and further another example of a pin connector.

FIG. 9 is a schematic diagram illustrating an example of a form of connection between a tuner device and a set.

FIG. 10 is a schematic diagram illustrating another example of a form of connection between a tuner device and a set.

FIG. 11 is a schematic diagram used to describe an example of connection of a core line of a connector.

FIG. 12 is a schematic diagram used to describe another example of connection of a core line of a connector.

FIG. 13 is a schematic diagram used to describe connection of a core line of a connector.

FIG. 14 is a schematic diagram used to describe an example of a tuner device having loop through output.

FIG. 15 is a schematic diagram used to describe another example of a tuner device having loop through output.

FIG. 16 is a front view of a working example of the present disclosure.

FIG. 17 is a schematic diagram for describing attachment to a set substrate of a working example of the present disclosure.

FIG. 18 is a perspective view of another working example of the present disclosure.

### DESCRIPTION OF EMBODIMENTS

The embodiment described below is a preferable specific example of the present disclosure, and is technically limited with preferable various limitations. However, in the following description, the scope of the present disclosure is not limited to these embodiments, unless it is described that the present disclosure is limited particularly. The following description will be made in the next order.
<1. Tuner Device of Past>
<2. One Embodiment>
<3. Exemplary Variant>

### 1. Tuner Device of Past

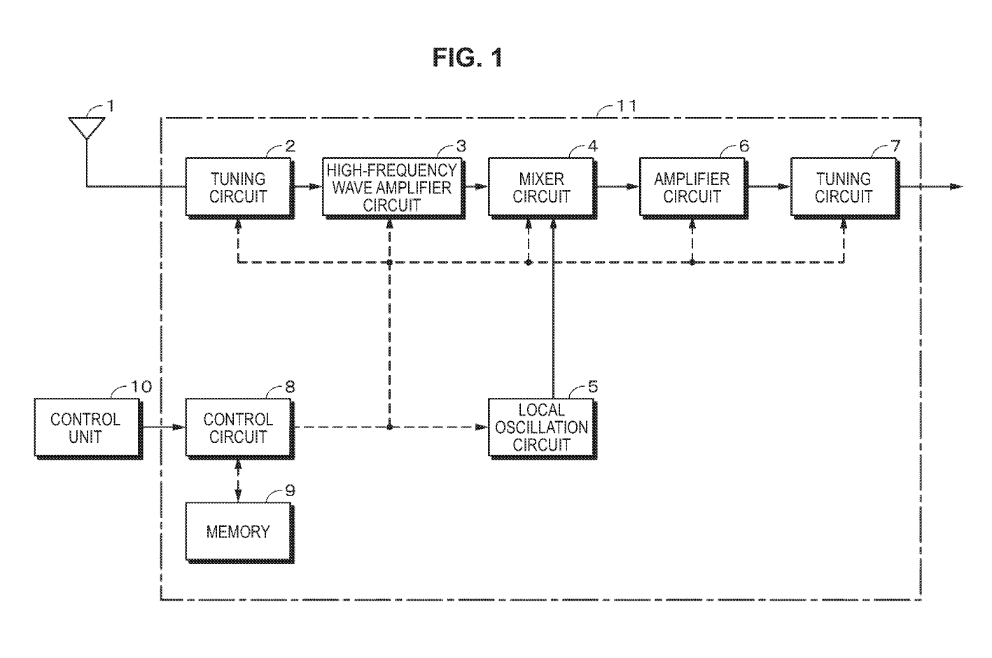

A circuit configuration of a tuner device of the past is illustrated in FIG. 1. In the tuner device, a signal from an antenna 1 is supplied to a tuning circuit 2, and an interfering wave signal is removed in the tuning circuit 2. An output signal of the tuning circuit 2 is amplified to a desired level in a high-frequency wave amplifier circuit 3.

The output signal of the high-frequency wave amplifier circuit 3 is supplied to the mixer circuit 4, and frequency conversion is performed by mixing the output signal with a local oscillation signal from a local oscillation circuit 5. The frequency conversion converts a desired wave signal to a desired frequency that depends on a demodulator of subsequent stage and the like. Further, the desired wave signal is amplified to a desired level by an amplifier circuit 6, and an interfering wave signal is removed by a tuning circuit 7.

The local oscillation circuit 5 is configured as a phase locked loop (PLL) circuit controlled by a control circuit 8. The control circuit 8 is controlled by an external control unit 10. A memory 9 is connected to the control circuit 8. Information necessary for control is stored in the memory 9.

From request for size reduction and cost reduction of tuner in recent years, effort is continuously made to integrate more functions of a tuner into a tuner IC. For example, in a tuner IC which is referred to as a mixer oscillator (MO) PLL-IC of the past, the mixer circuit 4, the amplifier circuit 6, a part of the local oscillation circuit 5, and the control circuit 8 are integrated in the tuner IC. In a silicon tuner IC 11 which is a flagship of tuner ICs of recent years, all functions except the control unit 10 are integrated, as illustrated with an alternate long and short dash line in FIG. 1.

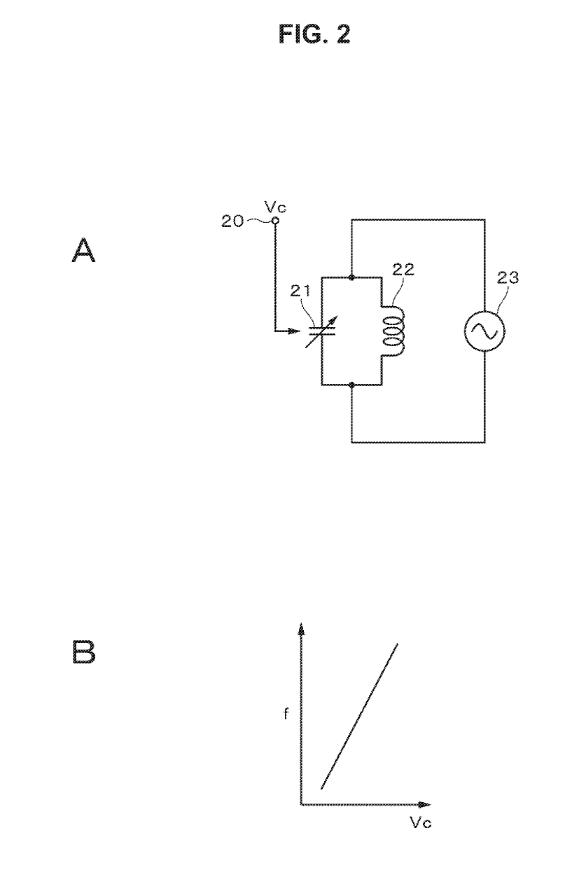

FIG. 2A illustrates a circuit example of a local oscillator in an MOPLL-IC, and FIG. 2B is a VCO curve (a curve of change of an oscillation frequency f with respect to a control voltage Vc). The control voltage Vc is supplied to the terminal 20, and a capacitance value of a capacitor 21 for voltage control tuning is controlled by the control voltage Vc. An LC resonator is configured with the capacitor 21 for voltage control tuning and an inductor 22 for tuning. A local oscillator is configured with the LC resonator and an element 23 for oscillator. Also, in an MOPLL of the past, a local oscillation frequency is identical with a source oscillation frequency in many cases.

The capacitor 21 for voltage control tuning is configured with a varicap diode which is a discrete component for example, and the control voltage supplied to the terminal 20 is approximately 0 to 32 V. A VCO curve illustrating a relationship between the control voltage Vc to the terminal 120 and the frequency of the oscillator is usually drawn with one line as illustrated in FIG. 2B, in such a manner to cover a required frequency range.

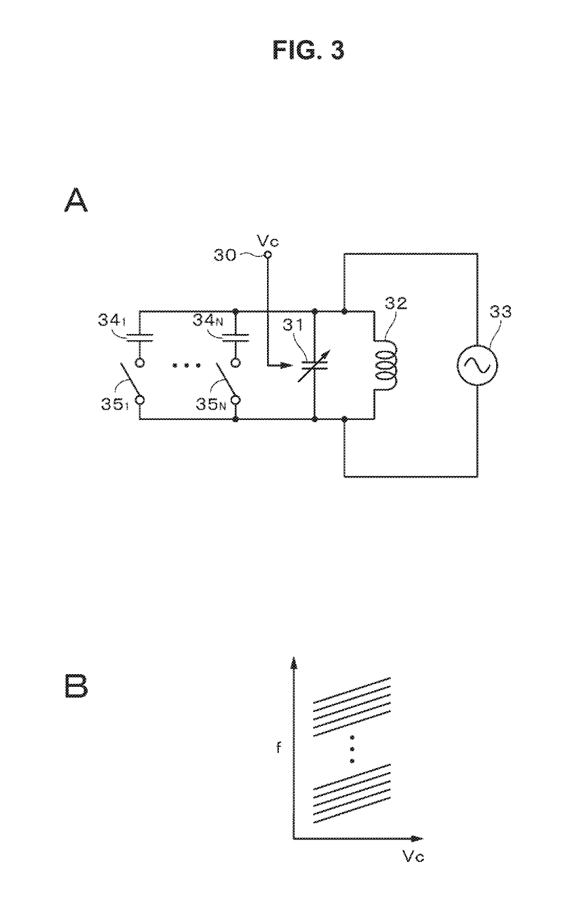

However, in the case of a silicon tuner IC, the capacitor 21 for voltage control tuning and the inductor 22 for tuning, which have been external components of the IC so far, are attempted to be integrated in the IC. In that case, it is difficult to integrate an element of a large capacitance value, capacitance variation range, inductance value, like a discrete component. A circuit configuration modified to clear this problem is illustrated in FIG. 3A.

In the same way as the configuration of FIG. 2A, an LC resonator is configured with a capacitor 31 for voltage control tuning whose capacitance value is controlled by a control voltage Vc from a terminal 30 and an inductor 32 for tuning, and an oscillator control element 33 is connected to an LC resonator. Further, series circuits including switch control tuning capacitors 34₁ to 34_{N} and switches 35₁ to 35_{N} respectively are connected in parallel to the capacitor 31 for voltage control tuning.

The value of tuning capacitance can be changed by controlling ON/OFF of the switches 35₁ to 35_{N}. Capacitors 34₁ to 34_{N} for switch control tuning are adjusted to a desired frequency and then switched, in order to compensate for decrease of the capacitance variation range of the capacitor 31 for voltage control tuning whose capacitance is controlled by the control voltage Vc. Further, the source oscillation frequency is set to a high frequency, for example approximately several GHz to 10 GHz, by the decrease of the inductance value of the inductor 32 for tuning, and thereafter the oscillation frequency is divided into a desired local frequency, in order to make a silicon tuner.

As illustrated in FIG. 3B, as VCO curves, subbands having discretely different oscillation frequencies f can be formed in the same variation range of the control voltage Vc. A set subband changes its frequency continuously in relation to the control voltage Vc, by changing the capacitor 31 for voltage control tuning, and the subband is switched by switching the capacitors 34₁ to 34_{N} for switch control tuning. A desired variable range becomes available by these controls.

As a result, a silicon tuner is formed to utilize high-frequency signals of several GHz to 10 GHz that have not been used so far, and there is a problem such as causing degradation of signal reception sensitivity for example, when a wave near the above frequency exists in an extraneous interfering wave for example.

In a CAN tuner or the like of the past having an F connector and an IEC connector in the housing, the tuner IC is internally provided in a structure that can easily form a cavity space. In other cases, it is internally provided in an end article. That is, the tuner IC is internally provided in some sort of housing, or is internally provided in a space that can be assumed to be a cavity space.

In this case, it is desired to reduce cavity resonance by an extraneous interfering wave, and to reduce cavity resonance by spurious radiation of a signal component in the tuner device, for example. From this view point, it is desirable that dimensions in arbitrary directions of the formed cavity space have dimensions that are equal to or smaller than a half wavelength λ2 [m] of a signal frequency inside the tuner device and an interfering wave from outside. However, as described above, a higher source oscillation frequency of the oscillator integrated in the tuner IC results in a problem that it becomes more difficult to achieve size reduction of the cavity space, and size reduction of the tuner device.

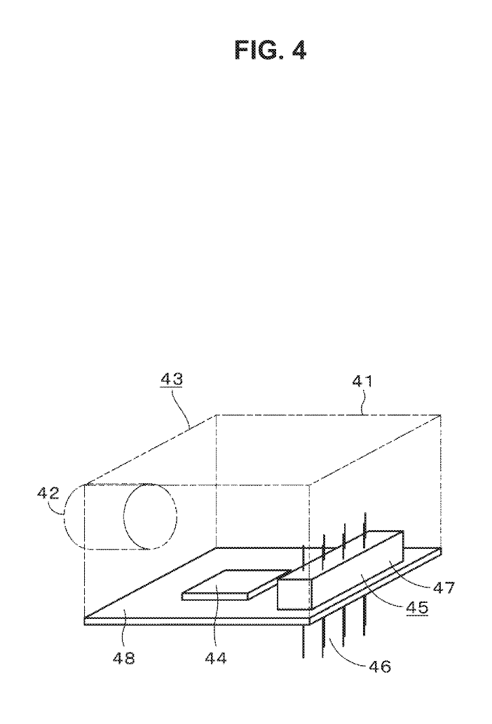

An exterior appearance of a widely used tuner device of the past is illustrated in FIG. 4. The mechanical housing 43 is structured by a metallic shield case 41 illustrated with an alternate long and two short dashes line and a connector 42 such as an F connector or an IEC connector attached to a shield case 41.

A print substrate 48 including a tuner IC 44 and a pin connector 45 mounted thereon is contained in the mechanical housing 43. The pin connector 45 includes a pin group 46 including a plurality of pins that protrude from inside to outside of the mechanical housing 43, and a pin connector mold 47 that retains the pin group 46.

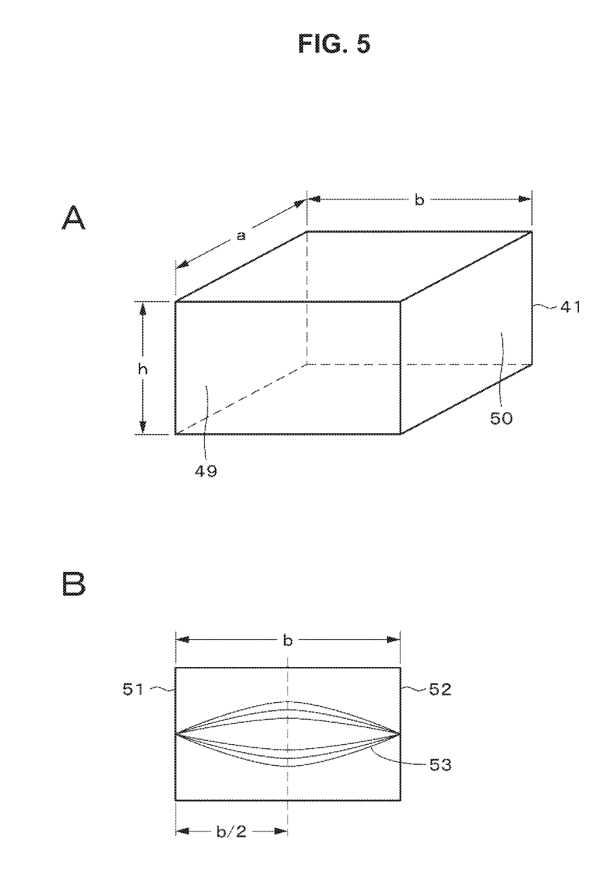

As illustrated in FIG. 5A, the metallic shield case 41 forms a cuboid cavity space whose vertical dimension, horizontal dimension, and height are dimension a, dimension b, and dimension h respectively, and can be assumed to be a λ/2 resonator with a left surface 49 and a right surface 50 as short circuit surfaces for example. An electric field at the time of resonance in the λ/2 resonator is illustrated in FIG. 5B. The surface 49 and the surface 50 behave as a short circuit surface 51 and a short circuit surface 52, respectively. A frequency component for which the dimension b is a half wavelength generates resonance as in an electric field distribution 53 in which the short circuit surfaces are nodes and a position at a half of dimension b/2 between the short circuit surfaces 51, 52 is an antinode of vibration. If an interfering wave of this resonance frequency enters into a tuner device, resonance occurs, and there is a problem that reception failure is caused when the resonance frequency is close to a frequency used in the tuner IC 44, for example.

### 2. One Embodiment

### “Size of Shield Case”

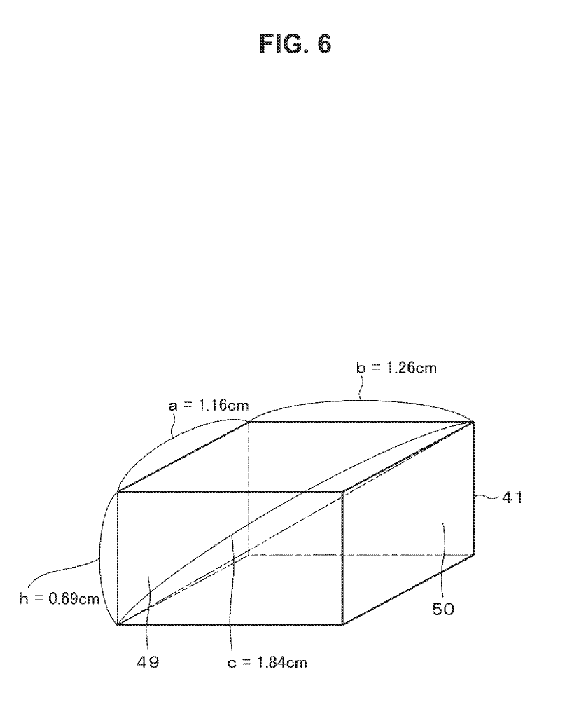

In one embodiment of the present disclosure, dimensions a, b, c, h of the shield case 41 is set as illustrated in FIG. 6. The dimension c is a distance between the farthest vertexes (referred to as a diagonal dimension). As a tuner IC, when the highest frequency of the source oscillation frequency of an internal oscillator is 8 GHz, λ/2 of 8 GHz is 1.875 cm. In this case, the relative permittivity of air is 1.00059, and therefore calculation is executed, assuming the relative permittivity as roughly 1.

The dimensions of FIG. 6 are dimensions inside the metallic shield case 41 containing a print substrate including a tuner IC mounted thereon. In the case of a λ/2 resonator, the vertical dimension a, the horizontal dimension size b, and the height dimension h of the formed shield case are set at 1.16 cm, 1.26 cm, and 0.69 cm, respectively. Further, the diagonal dimension c is set at 1.84 cm.

When an actual λ/2 resonator is considered, it is desired to consider any combination of short circuit surfaces of the metallic shield case 41. The largest dimension in the shield case 41 is the diagonal dimension c of opposing corners of the cuboid, and even this dimension c is equal to or smaller than 1.875 cm. Thus, resonance at or below 8 GHz is prevented from occurring, and interference with the oscillator does not occur, so as to achieve preferable reception. That is, the size of the shield case 41 is set in such a manner that the distance between any 2 points in the shield case 41 is equal to or smaller than a shorter size than a half wavelength of the highest frequency of the source oscillation frequencies of the oscillator of the equipped tuner IC.

### “Improvement of Pin Connector”

Further, in order to reduce the size of the tuner device, it is desired to improve the connector for connecting with the set substrate, which is represented by the pin connector or the like. For example, totally 6 pins are necessary as below, for a superheterodyne tuner device of a comparatively simple configuration used in a television receiver, which is controlled by inter-integrated circuit (I2C) communication.

Pin t1 (number 1): intermediate frequency output differential+side, pin t2 (number 2): intermediate frequency output differential−side, pin t3 (number 3): AGC control voltage terminal, pin t4 (number 4): SCL terminal for I2C communication, pin t5 (number 5): SDA terminal for I2C communication, pin t6 (number 6): power supply terminal

Further, totally 7 pins are necessary for a device used in a set top box and a recorder device for cable broadcast reception, because a pin t7 for loop through output is also necessary.

As described above, when 6 to 7 pins are necessary, it is undesirable that each pin is located at an arbitrary location in the tuner device without a rule, and pins are arranged on one straight line at one location in many cases, because of easiness of arrangement of lines on the set substrate. However, when considering a soldering process, it is desirable that the distance between the pins is far, from the view point of reduction of manufacturing failure such as solder bridge and the like. Thus, the dimension of the tuner device is defined by the dimension of the pin connector unit decided from a length obtained by multiplying the smallest pin interval that the production process allows by the number of pins.

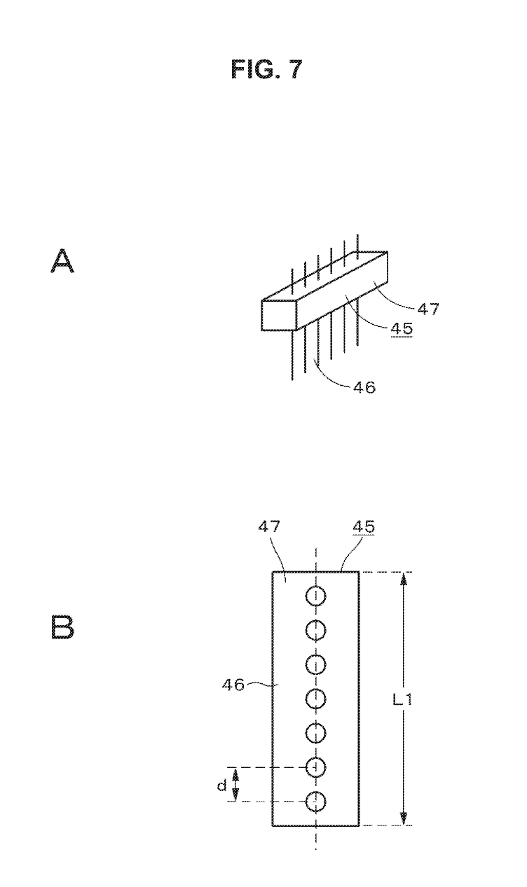

FIG. 7A illustrates the pin connector 45 arranged on one straight line and composed of 7 pins, for example. FIG. 7B is the pin connector 45 seen from its top face. In the pin connector 45, the pin group 46 including 7 pins t1 to t7 is aligned on one straight line, and is attached to the pin connector mold 47. In the pin group 46, an interval of adjacent pins is d. An interval d is the smallest pin interval that the production process allows, and for example when d is 2 mm, a length L1 of the pin connector 45 is 2 mm×7−1)+1 mm x×2=14 mm. In this case, the distances of the pins at both ends and end surfaces of the pin connector mold 47 is 1 mm. This is the limit value of miniaturization in a certain direction.

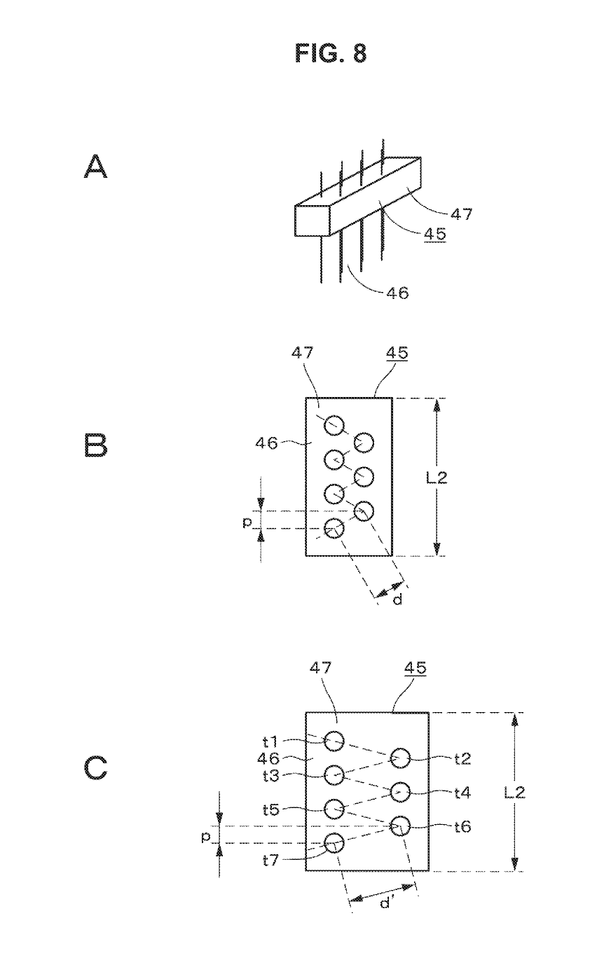

FIG. 8 illustrates an example that can reduce the size of the pin connector 45, by arranging the pin group 46 in a zig-zag arrangement. FIG. 8A illustrates the pin connector 45 composed of 7 pins and arranged in a zig-zag manner, for example. FIG. 8B is the pin connector 45 seen from its top face.

With this arrangement, when the dimension d decided by the smallest pin interval that the production process allows is 2 mm, the pin interval dimension p in the longitudinal direction of the pin connector 45 is 1.41 mm even in the case of 7 pins. Thus, the dimension L2 can be 1.41 mm×(7−1)+1 mm×2=10.46 mm, to make the dimension L2 smaller than the dimension L1 (14 mm) illustrated in FIG. 7B.

Further, as illustrated in FIG. 8C, the pin interval can be larger, and the functions of the pins t1 to t7 are assigned as below, for example.

t1: intermediate frequency output differential+side, t2: intermediate frequency output differential−side, t3: AGC control voltage terminal, t4: SCL terminal for I2C communication, t5: SDA terminal for I2C communication, t6: power supply terminal, t7: loop through output

In this case, the intermediate frequency output differential−side (the pin t2) and the AGC control voltage terminal (the pin t3) are adjacent pins. The signal level on the pin t2 is large to be near 0 dBm in many cases, and gain control is performed for the adjacent pin t3 at approximately 100 dB within the voltage range of 0 to several V, and thus these pins are susceptible to interference with extraneous noise. Thus, it is desirable that the pin t2 and the pin t3 are located as far as possible from each other.

As illustrated in FIG. 8C, the interval d′ of the pins t2 and t3 is set at 3 mm, while the pin interval dimension p in the longitudinal direction is maintained at 1.41 mm for example, so that the interval of each pin is enlarged while the dimension L2 is maintained.

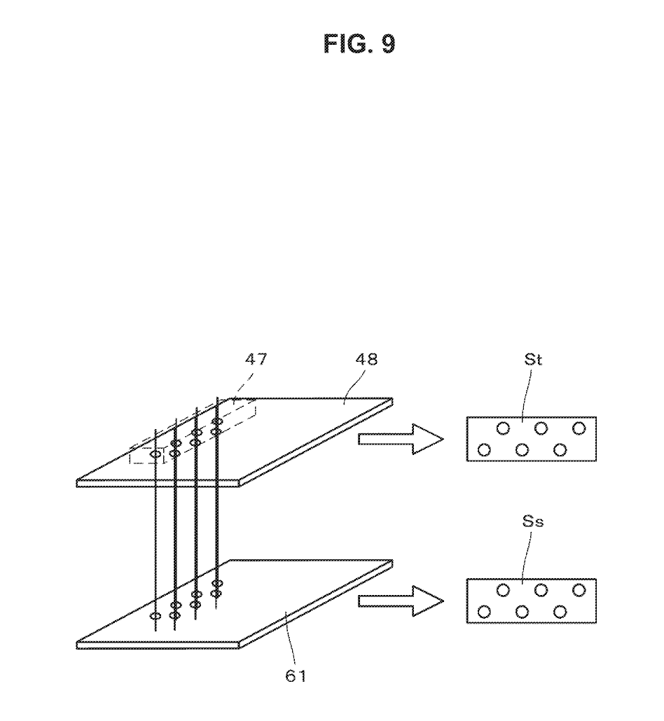

FIG. 9 illustrates a form of connection between a tuner device and a set (electronic device). The pin group 46 that is retained by the pin connector mold 47 of the tuner device and protrudes from the print substrate (tuner substrate) 48 is connected to a predetermined location of a set substrate 61. The pin group 46 is arranged in a zig-zag manner, and therefore an area St that the pin group 46 occupies on the print substrate 48 and an area Ss that the pin group 46 occupies on the set substrate are larger as compared with the arrangement of one straight line.

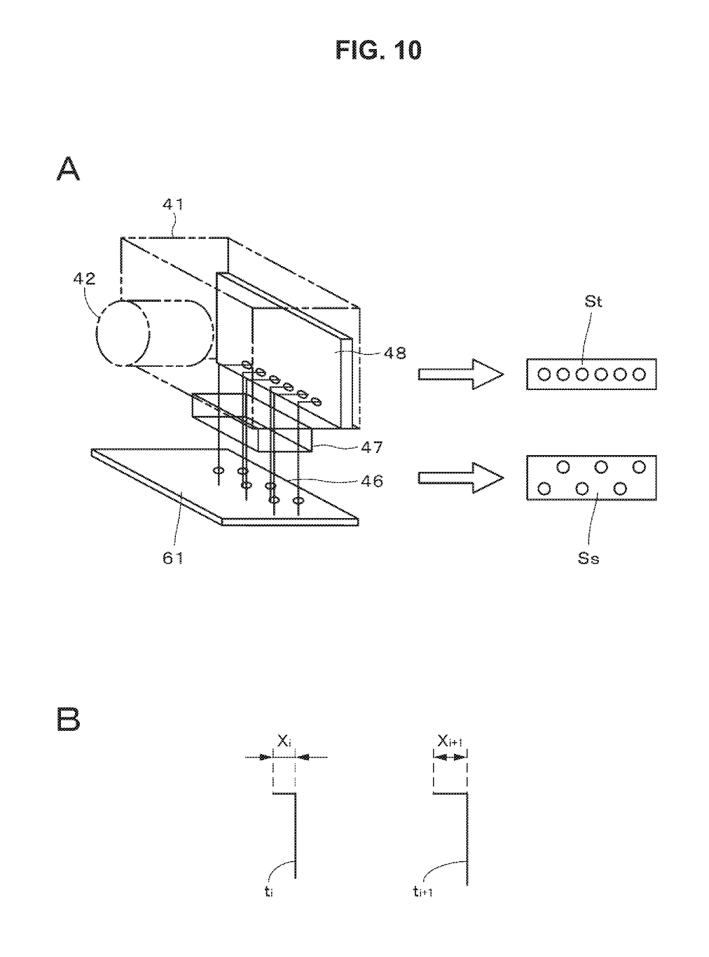

The one exemplary configuration that solves this problem will be described with reference to FIGS. 10A and 10B. Pin arrangement on the print substrate 48 is a straight line, and the pin group 46 is bent to form a substantially right angle in the shield case 41 and is led to the outside of the tuner device via the pin connector mold 47. As illustrated in FIG. 10B, the length from the position of the print substrate 48 to the bent position is differentiated between the adjacent pins. That is, when the length from the position of the print substrate 48 of the i-th pin ti to the bent position is xi, the length from the position of the print substrate 48 of i+1th pin ti+1 to the bent position is xi+1 (≠xi).

As described above, the pin arrangement in the pin connector mold 47 and the set substrate 61 can be zig-zag arrangement. Thus, the area St that the pin group 46 occupies on the print substrate 48 can be made smaller as compared with the configuration of FIG. 9, and the size of the pin connector mold 47 is reduced, so as to form an advantageous configuration for size reduction of the tuner device. As described above, the interval between the adjacent pins is set equal to or larger than a value d of acceptable limit, to prevent the length of the arrangement of the pin group 46 from being long. In this case, in the configuration of FIG. 10A, the interval between the adjacent pins on the print substrate 48 becomes smaller than the value d of acceptable limit. However, the interval between the pins can be set equal to or larger than d, when performing the work of soldering between the pins and the set substrate 61.

When reducing the size of the tuner device, the size reduction of the package of the equipped tuner IC is restricted because of the number of pins of the IC, and the proportion of the area that the tuner IC occupies on the substrate of the tuner device affects largely as the tuner device reduces its size. On the other hand, the tuner device has an F connector and an IEC connector in most cases, and the size of the tuner device is defined by the sizes of these connectors having standardized sizes, when reducing the size of the tuner device.

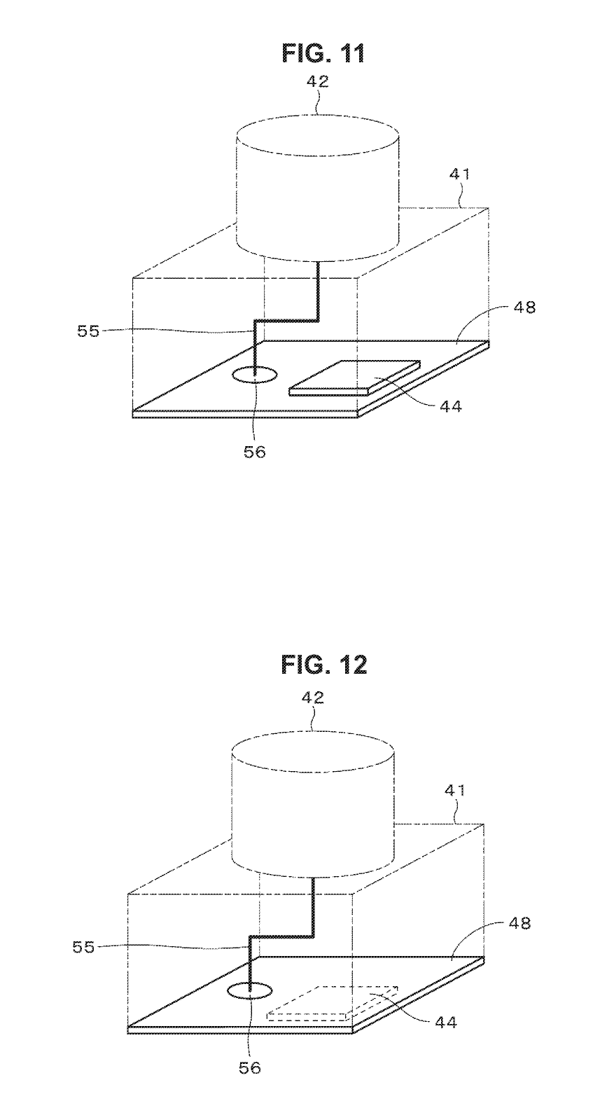

That is, as illustrated in FIG. 11, when the shield case 41 of the tuner device is made smaller to the almost same degree as the connector 42 such as an F connector or an IEC connector, a connector core line 55 is positioned near the center of the tuner substrate 48 straightly from the center of the connector 42. However, when the size of the tuner IC 44 is a size equal to or larger than ¼ of the substrate area, the tuner IC 44 certainly overlaps the center of the substrate 48 geometrically, and therefore the core line 55 is shaped in a crank shape for example to circumvent the tuner IC 44. Further, a through hole 56 formed in the print substrate 48 is used for leading out.

Further, in FIG. 11, the tuner IC 44 is mounted on the surface inside the shield case 41 of the print substrate 48. In contrast, as illustrated in FIG. 12, it is preferable that the tuner IC 44 is mounted on a surface outside the shield case 41 of the print substrate 48. Break-in of a spurious radiation component and interference are likely to occur, and it is concerned that the reception fails, at a location where the connector core line 55 is adjacent to the tuner IC 44 and a signal line or the like on the substrate 48. In the configuration of FIG. 12, isolation from the connector core line 55 is ensured to reduce mutual interference, by mounting the tuner IC 44 on the surface of the print substrate 48 on which the crank portion of the connector core line 55 does not exist.

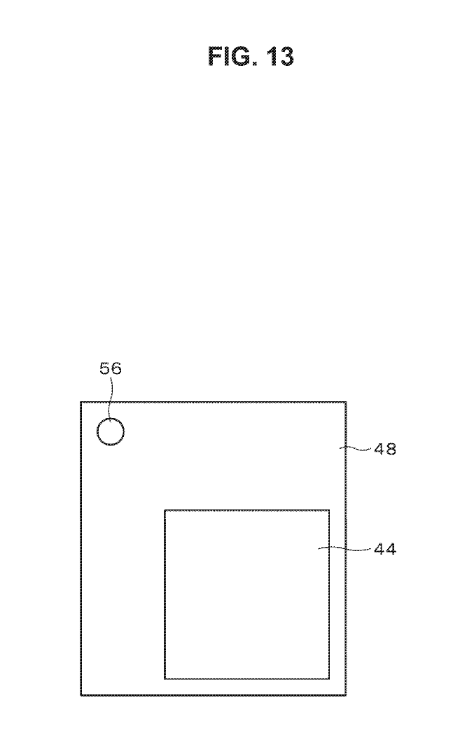

In the same way, it is desirable that the position of the through hole 56 (the core line 55) is as far as possible from the tuner IC 44, as illustrated in FIG. 13, in order to ensure the isolation. For example, the through hole 56 is formed at a vicinity of four corners of the print substrate 48 and at a position of the largest separation distance from the center of the tuner IC 44.

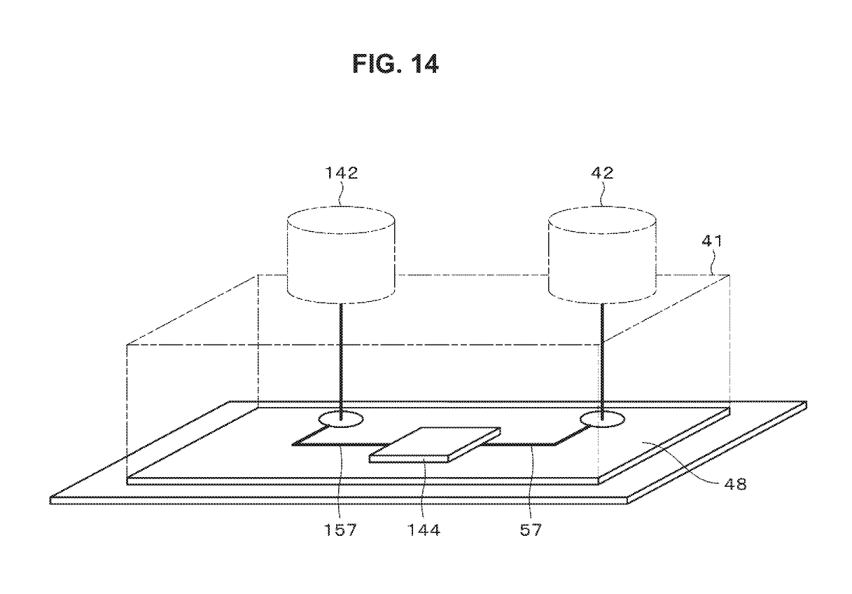

The tuner device equipped in cable television reception and a recorder for example is characterized in having loop through output. The frequency processed in the loop through circuit is that of broadcast waves, and needs to be prevented from attenuation of high-frequency signals by wiring a signal line on the print substrate for example. FIG. 14 illustrates an example of a tuner device having loop through output.

Although the configuration is the same as the widely used tuner device illustrated in FIG. 1 basically, a signal input from the F connector or the IEC connector 42 is supplied to a tuner IC 144 or the loop through circuit having the loop through output via the signal line 57 on the print substrate 48. Then, it is output from a connector 142 for the loop through output, such as an F connector or an IEC connector, via a signal line 157 from the tuner IC 144 or the loop through circuit.

In such a configuration, each set maker restricts the closest distance between the connector 42 and the connector 142 for loop through output, in order to ensure easiness in screwing in the coaxial cable, in many cases. As a result, the signal lines 57 and 157 become longer, increasing the possibility of attenuation of a high-frequency signal, for example.

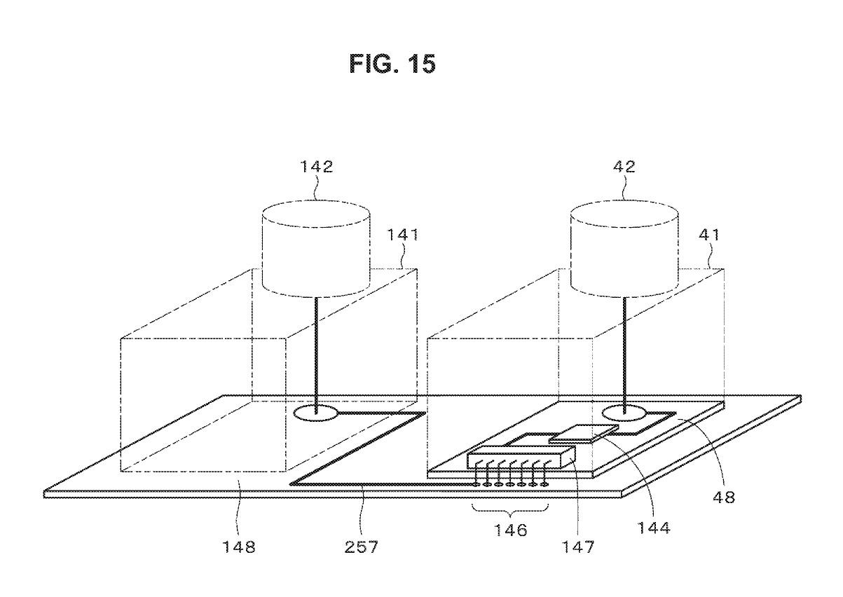

Further, as illustrated in FIG. 15, the shield case 41 of the F connector or the IEC connector (the connector 42) of the input side is separated from the shield case 141 of the connector 142 for loop through output, in some cases. In this case, the loop through output is often wired by a line 257 on a set substrate 148 on which the tuner device is equipped, creating a problem such as electric power loss caused by its line length.

Considering such a point, in FIG. 15, the line 257 of the loop through output is wired in such a manner to shorten the line 257. A signal line and a control line including a signal from the tuner IC 144 having the loop through output is connected to a pin connector group 146 grouped by a pin connector mold 147 or the like, with lines on the substrate. In order to shorten the line 257, the loop through output terminal is located at the closest side to the connector 142 for loop through output, in the arranged order of the pin connector group 146. With this arrangement, electric power loss by line length can be reduced.

### “Working Example”

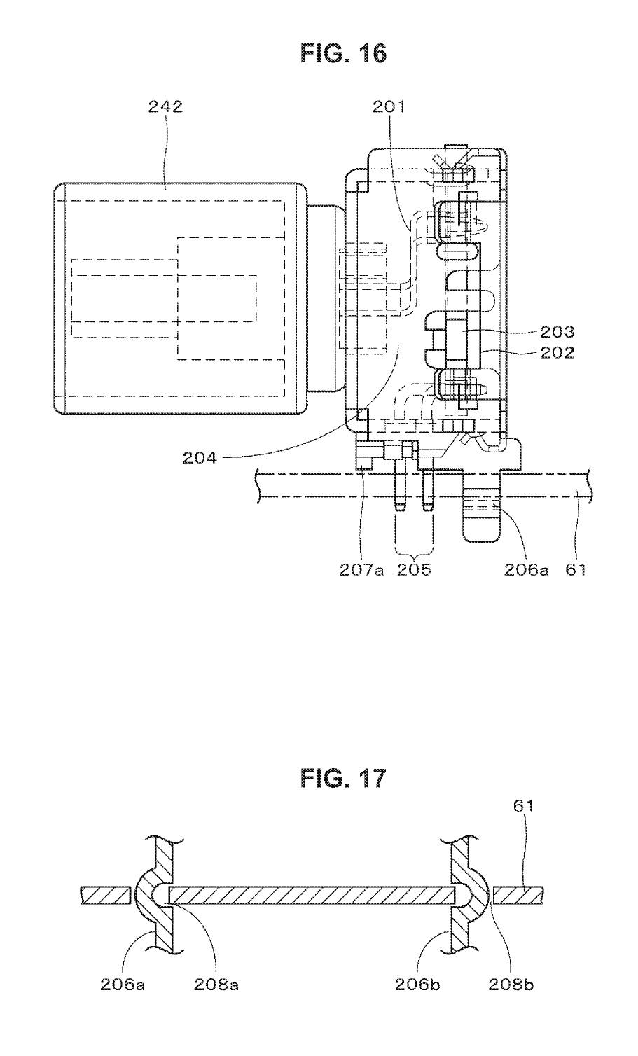

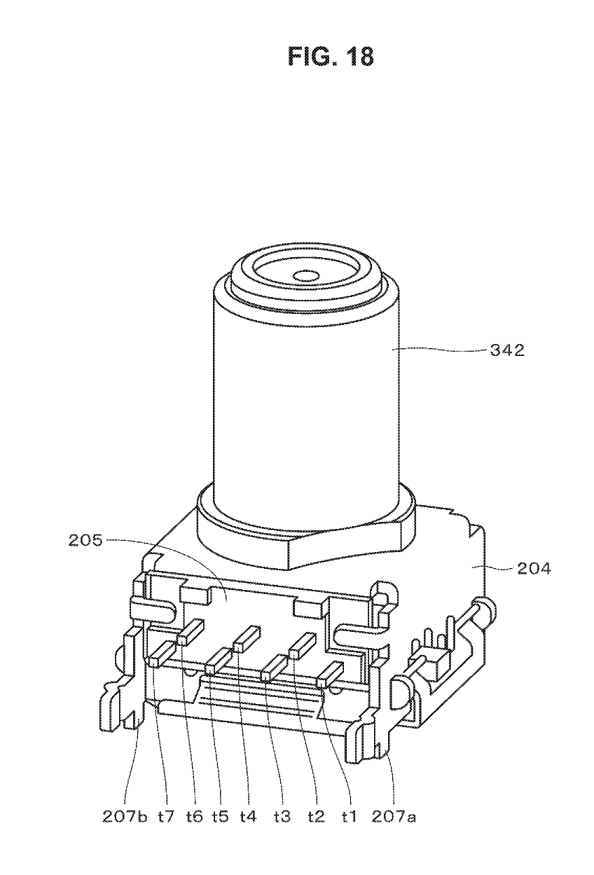

A working example of the present disclosure is illustrated in FIGS. 16 and 17, and another working example is illustrated in FIG. 18. The working example of FIG. 16 includes an IEC connector 242, and the working example of FIG. 16 includes an F connector 342. A core line 201 of the IEC connector 242 is formed in a crank shape. A tuner IC 202 whose highest frequency of the source oscillation frequency of the internal oscillator is 8 GHz is mounted on the opposite side to the core line 201 of the IEC connector with a substrate 203 therebetween, and a metallic shield case 204 of the dimensions illustrated in FIG. 6 is used as a housing.

Such a tuner device is mounted on the set substrate 61. A pin group 205 of zig-zag arrangement of the tuner device is inserted into a through hole provided in the set substrate 61. Further, the tuner device includes attachment leg portions 206a and 206b having spring characteristics, which protrudes in parallel with the pin group 205. Further, protrusions 207a and 207b are provided at a close side to the IEC connector 242 of the pin connector mold that supports the pin group 205.

As illustrated in FIG. 17, the attachment leg portions 206a and 206b are inserted into penetration holes 208a and 208b provided in the set substrate 61. Retaining effect is achieved by convex portions provided in the attachment leg portions 206a and 206b. Further, the protrusions 207a and 207b are in contact with a front surface of the set substrate 61 after mounted, and therefore the tuner device is prevented from rotating by its own weight. In this way, the tuner device is mounted on the set substrate 61 without failure. For example, soldering is performed by a reflow device in this mounted state.

Another working example illustrated in FIG. 18 has the same configuration as the above working example, except the point having the F connector 342. Corresponding parts are denoted with the same reference signs. Of the pins t1 to t7, the pin t7 is the pin for loop through output.

### 3. Exemplary Variant

Although, in the above, the embodiments of the present disclosure have been described specifically, the above each embodiment is not a limitation, but various types of transformation can be made based on the technical idea of the present disclosure. For example, the configuration, the method, the process, the shape, the material, the numerical value, etc. which are described in the above embodiments are just examples, and the different configuration, method, process, shape, material, numerical value, etc. may be used as necessary. For example, the present disclosure can be applied, when using a tuner IC having both of a tuner for digital television broadcast and a tuner for BS broadcast.

Additionally, the present technology may also be configured as below.

(1) A tuner device including:

a housing having a vertical dimension, a horizontal dimension, a height dimension, a diagonal dimension, and an arbitrary dimension that are each shorter than a half wavelength of a maximum frequency of a source oscillation frequency of an oscillator of a tuner IC that is contained in the housing.

(2) The tuner device according to (1), wherein

the tuner IC includes a local oscillator, and processes a high-frequency signal of several GHz to 10 GHz.

(3) The tuner device according to (1) or (2), wherein pin positions in a pin connector including a plurality of pins connected to the tuner IC are arranged in a zig-zag manner, and

the pin connector has a size shorter than a length decided by multiplying a number of the pins and a pin interval of the pin connector.

(4) The tuner device according to any of (1) to (3), wherein

the plurality of pins are arranged along a straight line, on a print substrate, and

the plurality of pins are bent, and

dimensions to bent positions of the pins have alternate different values, so that positions for leading out the pins are arranged in a zig-zag manner.

(5) The tuner device according to any of (1) to (4), wherein

a tuner IC is mounted on a surface outside a print substrate, and

a core line of a connector is bent in a crank shape and connected to the tuner IC.

(6) The tuner device according to any of (1) to (5), including:

a connector for loop through output,

wherein a line to the connector for loop through output has a pin for loop through output at a close position to the connector for loop through output on a pin connector arrangement.

(7) The tuner device according to any of (1) to (6), including:

an attachment leg portion extending in substantially a same direction as the pins of the pin connector and inserted into a hole formed in the substrate; and

a protrusion for blocking rotation by a weight of the connector.

### REFERENCE SIGNS LIST

5 local oscillator
11, 44 tuner IC
41 shield case
42 connector
46 pin group
47 pin connector mold
48 print substrate
61 set substrate

1. A tuner device comprising:
a housing having a vertical dimension, a horizontal dimension, a height dimension, a diagonal dimension, and an arbitrary dimension that are each shorter than a half wavelength of a maximum frequency of a source oscillation frequency of an oscillator of a tuner IC that is contained in the housing.

2. The tuner device according to claim 1, wherein
the tuner IC includes a local oscillator, and processes a high-frequency signal of several GHz to 10 GHz.

3. The tuner device according to claim 1, wherein
pin positions in a pin connector including a plurality of pins connected to the tuner IC are arranged in a zig-zag manner, and
the pin connector has a size shorter than a length decided by multiplying a number of the pins and a pin interval of the pin connector.

4. The tuner device according to claim 3, wherein
the plurality of pins are arranged along a straight line, on a print substrate, and
the plurality of pins are bent, and
dimensions to bent positions of the pins have alternate different values, so that positions for leading out the pins are arranged in a zig-zag manner.

5. The tuner device according to claim 3, wherein
a tuner IC is mounted on a surface outside a print substrate, and
a core line of a connector is bent in a crank shape and connected to the tuner IC.

6. The tuner device according to claim 3, comprising:
a connector for loop through output,
wherein a line to the connector for loop through output has a pin for loop through output at a close position to the connector for loop through output on a pin connector arrangement.

7. The tuner device according to claim 3, comprising:
an attachment leg portion extending in substantially a same direction as the pins of the pin connector and inserted into a hole formed in the substrate; and
a protrusion for blocking rotation by a weight of the connector.
